(19) United States
(12) Patent Application Publication
(10) Pub. No.: US 2015/0370880 A1
(43) Pub. Date: Dec. 24, 2015

(54) IDENTIFYING ITEMS ON A SECOND WEBSITE ALREADY BROWSED AT A FIRST WEBSITE

(71) Applicant: International Business Machines Corporation, Armonk, NY (US)

(72) Inventors: James Hewitt, Eastleigh (GB); Richard Postlethwaite, Salisbury (GB); Caroline J. Thomas, Eastleigh (GB)

(21) Appl. No.: 14/707,462

(22) Filed: May 8, 2015

(30) Foreign Application Priority Data
Jun. 20, 2014 (GB) 1410998.7

(51) Int. Cl. G06F 17/30; H04L 29/08

(52) U.S. Cl. CPC G06F 17/30589; G06F 17/3053; G06F 17/30554; H04L 67/02

(57) ABSTRACT

For browsing items on the worldwide web, operations are performed, including: searching for items to browse at a first website; recording attributes of each item browsed at the first website; searching for items to browse at a second website; comparing attributes of items identified during the searching of the second website with the recorded attributes of items browsed at the first website; in the event of a match between attributes of an item identified during the searching of the second website and the recorded attributes of an item browsed at the first website, indicating that the item identified at the second website is the same as the item browsed at the first website; and displaying an indication to the user that the item identified at the second website is the same as the item browsed at the first website.

### FIELD OF THE INVENTION

The present invention relates to identifying previously seen items on a website, and more particularly to identifying items at a second website that have already been browsed at a first website.

### BACKGROUND

It is known to list items (for example, items for sale) on websites so that numerous and geographically distributed users can view the items and/or information associated with the items (for example, price, a small image of the item).

### BRIEF SUMMARY OF THE INVENTION

According to one aspect of the present invention, a system for browsing items on the worldwide web includes:

a generator for recording attributes of each item browsed at the first website in a data store;
a comparator for comparing attributes of items identified during the searching of a second website with the recorded attributes of items browsed at the first website; and
a manipulator, responsive to the comparator identifying a match between attributes of an item identified during the searching of the second website and the recorded attributes of an item browsed at the first website, for indicating that the item identified at the second website is the same as the item browsed at the first website and displaying an indication to the user that the item identified at the second website is the same as the item browsed at the first website.

According to a further aspect of the present invention, there is a method, system and/or computer program product for performing the following operations (not necessarily in the following order):

searching for items to browse at a first website;
recording attributes of each item browsed at the first website;
searching for items to browse at a second website;
comparing attributes of items identified during the searching of the second website with the recorded attributes of items browsed at the first website;
in the event of a match between attributes of an item identified during the searching of the second website and the recorded attributes of an item browsed at the first website, indicating that the item identified at the second website is the same as the item browsed at the first website; and
displaying an indication to the user that the item identified at the second website is the same as the item browsed at the first website.

### BRIEF DESCRIPTION OF THE DRAWINGS

Preferred embodiments of the present invention will now be described in more detail, by way of example only, with reference to the accompanying drawings, in which:

FIG. 1 shows a block diagram of a first embodiment of the present invention;

FIG. 2 shows a portion of a second embodiment of the present invention; and

FIG. 3 shows a flow chart of embodiments of an embodiment of a method according to the present invention.

### DETAILED DESCRIPTION OF THE EMBODIMENTS

When searching for an item on websites listing many items of a similar nature, the same item often appears on more than one website, but with a different name. When a user is browsing multiple websites, some embodiments of the present invention make it less difficult to determine if the item has previously been seen before. This can prevent a situation where a user fails to look at, and/or closely review, an item which is unique to a website because of the large amount of duplicated information. For example, when searching for short-let rental properties for holidays, the same property often appears on more than one website, but with a different name. In some embodiments of the present invention, it is easier for a user to determine if the user has seen the property before when browsing multiple websites. This can prevent the user from neglecting to look at properties unique to a website because of the large amount of extraneous information encountered in a typical web searching session.

Some embodiments of the invention provide a method for browsing items on the worldwide web, the method including the following (not necessarily in the following order): searching for items to browse at a first website; recording attributes of each item browsed at the first website;

searching for items to browse at a second website; comparing attributes of items identified during the searching of the second website with the recorded attributes of items browsed at the first website;
in the event of a match between attributes of an item identified during the searching of the second website and the recorded attributes of an item browsed at the first website, indicating that the item identified at the second website is the same as the item browsed at the first website; and
displaying an indication to the user that the item identified at the second website is the same as the item browsed at the first website. Some embodiments of the present invention may have the advantage that the items at the second website can be viewed in a more efficient manner.

In one embodiment, displaying the indication to a user includes greying out the display of the item identified as having attributes at a first website which match corresponding attributes at a second website. Some embodiments of the present invention may have the advantage that the user can see that the link is one that has already been viewed and may not need to be viewed again.

In another embodiment, displaying the indication to a user includes lowering the ranking on a search results page of the item identified as having attributes at a first website which match corresponding attributes at a second website. Some embodiments may have the advantage that the user sees items that have not been previously viewed before seeing items that have been previously viewed.

Embodiments of the invention also provide a computer program product for browsing items on the worldwide web, the computer program product comprising: a computer readable storage medium having computer readable program code embodied therewith, the computer readable program code adapted to perform the method described above when the program is run on a computer.

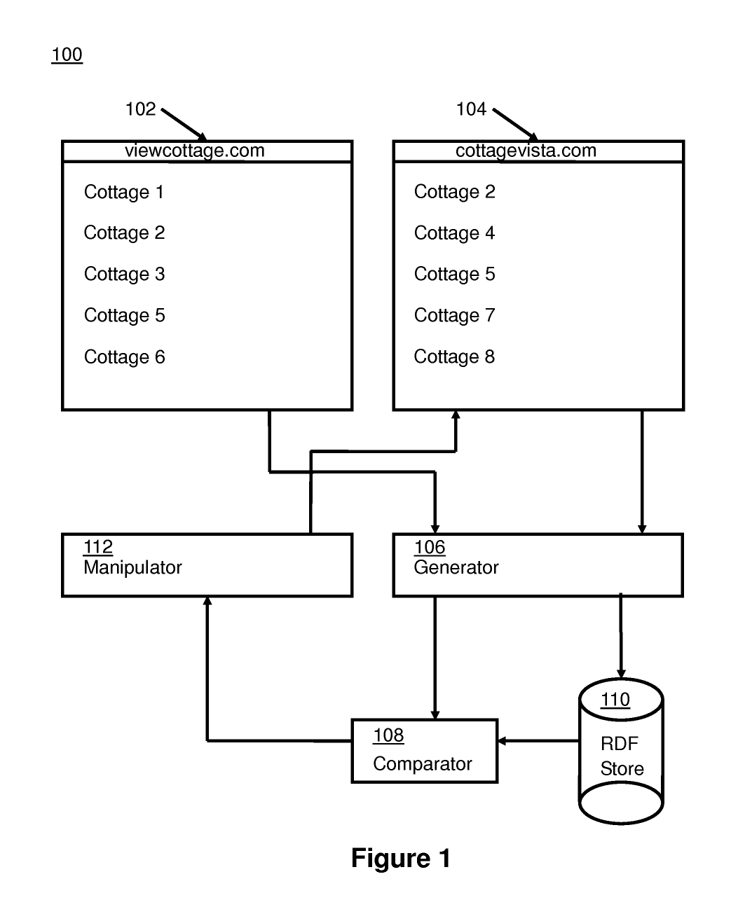

When a user is browsing multiple websites looking for a particular item, the particular item may appear on more than one website, but with a different name. For example, when searching for short-let rental properties for holidays, the same property often appears on more than one website, but with a different name. FIG. 1 shows search results from two such websites viewcottage.com 102 and cottagevista.com 104. viewcottage.com 102 shows five such results for cottages matching a search criteria. These are shown in FIG. 1 as Cottage 1, Cottage 2, Cottage 3, Cottage 5 and Cottage 6. cottagevista.com 104 shows a different five such results, shown in FIG. 1 as Cottage 2, Cottage 4, Cottage 5, Cottage 7 and Cottage 8.

When a user browses, for example, the details for Cottage 1 on a first website viewcottage.com 102, the generator 106 maintains a Resource Description Framework (RDF) store 110 with information about Cottage 1. Embodiments of the present invention may record information about each of the short-let rental properties, such as size, location and any images appearing in the information about the particular short-let rental property. Other information may include a description of the property or a video tour of the property. Other embodiments of the present invention may record information about tourist attractions, domestic appliances, cars or any other item which may be searched for on two or more websites. An embodiment of the present invention will be described using short-let rental properties as an example, but other embodiments of the invention are not restricted to short-let rental properties. The item being searched for is irrelevant to the implementation of embodiments of the present invention. A Resource Description Framework is a conceptual description of information that is implemented in web resources. The RDF 1.1 specification was published by the World Wide Web Consortium (W3C) in 2014. Details can be found at www.w3.org/rdf.

A user may also search on the first website viewcottage.com 102, with the search returning links for short-let rental properties Cottage 1, Cottage 2, Cottage 3, Cottage 5 and Cottage 6. The search results may be ranked in order by popularity based on various factors. The popularity may be determined by the number of times the link in search results has been clicked from that website, the number of times the property is “liked” or shared on a social media network such as Facebook® or the number of times the property has been tweeted, that is posted to a limited-character-post blogging service.

The generator 106 generates information about each of the short-term rental properties corresponding to each of the links from viewcottage.com 102 and stores the generated information in the RDF store 110. The comparator 108 compares the generated information for each of the links with information already stored in the RDF store 110 for previously seen items. Information such as size, location or a description of the property may be compared using conventional text comparison techniques and any images appearing in the information about the particular short-let rental property may be compared using conventional image comparison techniques. Other information may include a description of the property or a video tour of the property.

The user now searches on a second website cottagevista.com 104, with the search this time returning links for Cottage 2, Cottage 4, Cottage 5, Cottage 7 and Cottage 8. The generator 106 generates information about each of the short-term rental properties corresponding to each of the links from cottagevista.com 104 and stores the generated information in the RDF store 110. The comparator 108 compares the generated information for each of the links from cottagevista.com 104 with the information already stored in the RDF store 110 for previously seen items.

In the example of FIG. 1, the comparator 108 finds matches between the link for Cottage 2 at each of the viewcottage.com 102 and cottagevista.com 104 websites. Similarly, the comparator 108 finds matches between the link for Cottage 5 at each of the viewcottage.com 102 and cottagevista.com 104 websites. The match may be a textual match, an image match achieved by image comparison or any other match using known techniques for the comparison of data. The comparator 108 may rely on confidence levels, that is, it may be 80% confident that the property found on the first website viewcottage.com 102 and on the second website cottagevista.com 104 are the same property. The manipulator 112 manipulates the link to and/or the displayed web page to add contextual information for the user. In an embodiment, the manipulator 112 may be a browser extension.

Adding contextual information may include greying out the links in the search results for cottagevista.com 104 which correspond to matches already seen on the website viewcottage.com 102. In FIG. 1, the links for Cottage 2 and Cottage 5 are shown greyed out. In an embodiment, these links are greyed out and may not be available for selection. In another embodiment, the links are greyed out to show the user that they have already seen these links, but the user may, nevertheless, be able to click on the links. The greying out is achieved by the manipulator 112 manipulating the link to add contextual information for the user.

Adding contextual information may include adding a link to the displayed web page for cottagevista.com 104 that links to the already seen web page for the same property on viewcottage.com 102. The addition of the link is achieved by the manipulator 112 manipulating the displayed web page to add contextual information for the user.

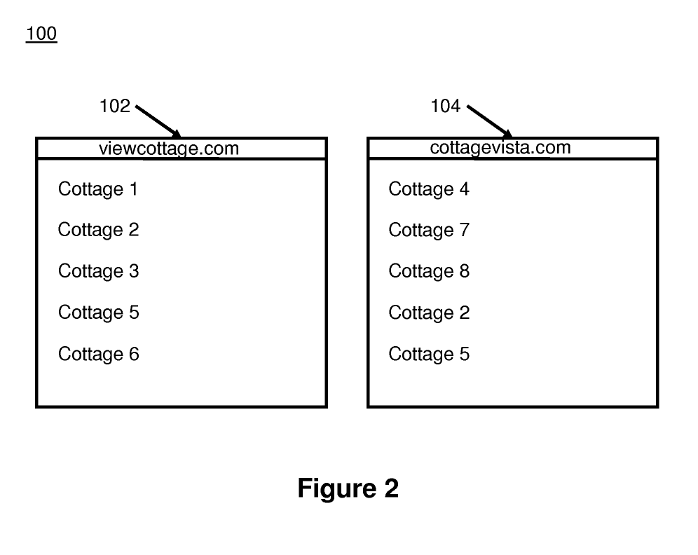

FIG. 2 shows another embodiment of the contextual information shown to the user. The links for Cottage 2 and Cottage 5 are lowered in the order of results displayed in the search results to the user. In the embodiment of FIG. 2, the links for Cottage 2 and Cottage 5 are displayed at the bottom of the search results below the links for Cottage 4, Cottage 7 and Cottage 8. In other embodiments, the links for matches already seen on another website may be lowered in order, but not moved to the bottom of the list of search results. The lowering of the matches in the order of the results displayed to the user is achieved by the manipulator 112 manipulating the search results page.

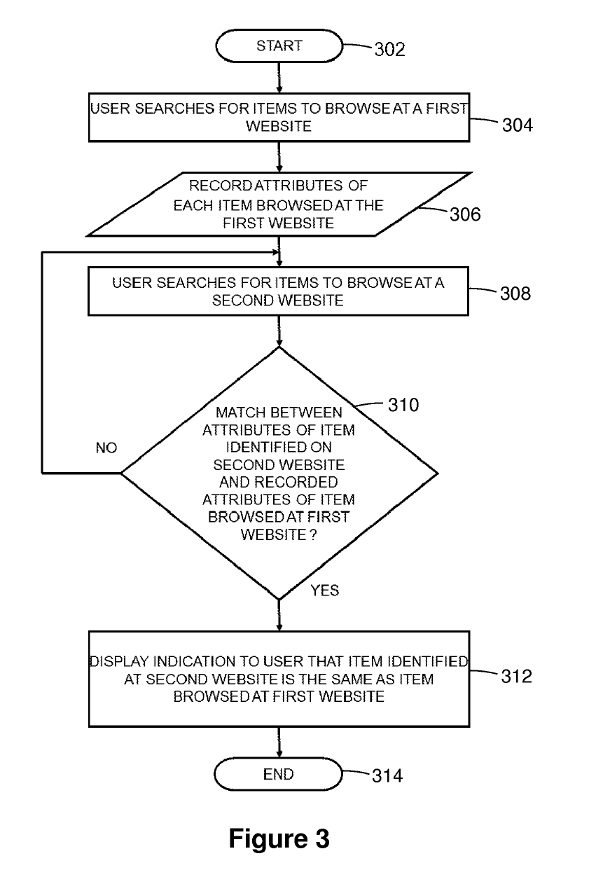

FIG. 3 shows a flow chart for an embodiment of a method according to the present invention. The method starts at step 302. At step 304, a user searches for items to browse at a first website. A user may browse, for example, the details for Cottage 1 on a first website viewcottage.com 102. As mentioned above, the items searched for may be tourist attractions, domestic appliances, cars or any other item which may be searched for on two or more websites. At step 306, the generator 106 records attributes of each item browsed at the first website, such as viewcottage.com 102 and maintains a Resource Description Framework (RDF) store 110 with information about the browsed item Cottage 1. Examples of such attributes include size, location and any images appearing in the information about the particular short-let rental property. Other information may include a description of the property or a video tour of the property. The user may continue searching for and browsing further items at the first website viewcottage.com 102. These items may include Cottage 2, Cottage 3, Cottage 5 and Cottage 6. The generator 106 records attributes of each of these items browsed at the first website viewcottage.com 102 and maintains a RDF store 110 with information about the browsed items Cottage 2, Cottage 3, Cottage 5 and Cottage 6. In an embodiment of the invention, the attributes may be metadata.

At step 308, the user now searches for items to browse at a second website. Search results displayed to the user may include, for example, the details for Cottage 2 at the second website cottagevista.com 104. The search results may further include the details for Cottage 4, Cottage 5, Cottage 7 and Cottage 8. At step 310, the generator 106 generates information about each of the short-term rental properties corresponding to each of the links from cottagevista.com 104 and stores the generated information in the RDF store 110. The comparator 108 compares the generated information for each of the links from cottagevista.com 104 with information already stored in the RDF store 110. In the example of FIG. 1, the comparator 108 finds matches between the link for Cottage 2 at each of the first website viewcottage.com 102 and the second website cottagevista.com 104. Similarly, the comparator 108 finds matches between the link for Cottage 5 at each of the viewcottage.com 102 and cottagevista.com 104 websites. The match may be a textual match, an image match achieved by image comparison or any other match using known techniques for the comparison of data. The comparator 108 may rely on confidence levels, that is, it may be 80% confident that the property found on the first website viewcottage.com 102 and on the second website cottagevista.com 104 are the same property.

If the user selects a link on the second website corresponding to one of the items for which the comparator 108 finds no match between the attributes of the item on the second website and any recorded attributes stored in the RDF store 110 corresponding to the same item viewed on another website, such as the first website, then the contents of the link are displayed to the user with no manipulation. The method returns to step 308 and waits for the user to search for another item or to view another item from the displayed search results. As an example, the user may select the link for Cottage 4 on the second website cottagevista.com 104, the attributes of which do not correspond with any previously stored attributes in the RDF store 110.

If the user selects a link on the second website corresponding to one of the items for which the comparator 108 finds a match between the attributes of the item on the second website and the recorded attributes stored in RDF store 110 corresponding to the same item viewed on another website, such as the first website, then processing continues to step 312. As an example, the user may select the link for Cottage 2 on the second website cottagevista.com 104, the attributes of which correspond with the previously stored attributes in the RDF store 110 for Cottage 2 on the first website viewcottage.com 102. Although, for the purposes of clarity, the same name Cottage 2 has been used in FIG. 1 for the links on each of the first website and the second website, in practice, the two links may use different names such as “Rose Cottage” and “Cottage”.

At step 312, the manipulator 112 displays an indication to the user that the item identified at the second website is the same as an item browsed at the first website. In the example of FIG. 1, this may be that Cottage 2 at the second website cottagevista.com 104 has already been browsed at the first website viewcottage.com 102. The manipulator 112 manipulates the link to the web page or the displayed web page for Cottage 2 to add contextual information to the user.

Displaying contextual information may include greying out the links in the search results for cottagevista.com 104 which correspond to matches already seen on the website viewcottage.com 102. In FIG. 1, the links for Cottage 2 and Cottage 5 are shown greyed out. In an embodiment, these links are greyed out and may not be available for selection. In another embodiment, the links are greyed out to show the user that they have already seen these links, but the user may, nevertheless, be able to click on the links. The greying out is achieved by the manipulator 112 manipulating the link to add contextual information for the user.

Adding contextual information may include adding a link to the displayed web page for cottagevista.com 104 that links to the already seen web page for the same property on viewcottage.com 102. This indicates to the user that the user has already viewed this property on the first website and also provides the user with a link to view the property on the first website again. The method ends at step 314. The addition of the link is achieved by the manipulator 112 manipulating the displayed web page to add contextual information for the user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for browsing items on the worldwide web, the method comprising:
searching for items to browse at a first website;
recording attributes of each item browsed at the first website;
searching for items to browse at a second website;
comparing attributes of items identified during the searching of the second website with the recorded attributes of items browsed at the first website;
in the event of a match between attributes of an item identified during the searching of the second website and the recorded attributes of an item browsed at the first website, indicating that the item identified at the second website is the same as the item browsed at the first website; and
displaying an indication to the user that the item identified at the second website is the same as the item browsed at the first website.

2. A method as claimed in claim 1, wherein the attributes are recorded in a RDF data store.

3. A method as claimed in claim 1, wherein displaying the indication to a user includes greying out the display of the item identified as having attributes at a first website which match corresponding attributes at a second website.

4. A method as claimed in claim 1, wherein displaying the indication to a user includes lowering the ranking on a search results page of the item identified as having attributes at a first website which match corresponding attributes at a second website.

5. A method as claimed in claim 1, wherein the items include property details and the attributes of each item include one or more of size, location and images.

6. A system for browsing items on the worldwide web, the system comprising:
a generator for recording attributes of each item browsed at the first website in a data store;
a comparator for comparing attributes of items identified during the searching of a second website with the recorded attributes of items browsed at the first website; and
a manipulator, responsive to the comparator identifying a match between attributes of an item identified during the searching of the second website and the recorded attributes of an item browsed at the first website, for indicating that the item identified at the second website is the same as the item browsed at the first website and displaying an indication to the user that the item identified at the second website is the same as the item browsed at the first website.

7. A system as claimed in claim 6, wherein the data store is a RDF data store.

8. A system as claimed in claim 6, wherein the manipulator greys out the display of the item identified as having attributes at a first website which match corresponding attributes at a second website.

9. A system as claimed in claim 6, wherein the manipulator lowers the ranking on a search results page of the item identified as having attributes at a first website which match corresponding attributes at a second website.

10. A system as claimed in claim 6, wherein the items include property details and the attributes of each item include one or more of size, location and images.

11. A computer program product for browsing items on the worldwide web, the computer program product comprising a computer readable storage medium having stored thereon:
first program instructions programmed to search for items to browse at a first website;
second program instructions programmed to record attributes of each item browsed at the first website;
third program instructions programmed to search for items to browse at a second website;
fourth program instructions programmed to compare attributes of items identified during the searching of the second website with the recorded attributes of items browsed at the first website;
fifth program instructions programmed to, in the event of a match between attributes of an item identified during the searching of the second website and the recorded attributes of an item browsed at the first website, indicate that the item identified at the second website is the same as the item browsed at the first website; and
sixth program instructions programmed to display an indication to the user that the item identified at the second website is the same as the item browsed at the first website.

12. The product of claim 11, wherein the attributes are recorded in a RDF data store.

13. The product of claim 11, wherein displaying the indication to a user includes greying out the display of the item identified as having attributes at a first website which match corresponding attributes at a second website.

14. The product of claim 11, wherein displaying the indication to a user includes lowering the ranking on a search results page of the item identified as having attributes at a first website which match corresponding attributes at a second website.

15. The product of claim 11, wherein the items include property details and the attributes of each item include one or more of size, location and images.
